(19) United States
(12) Patent Application Publication
(10) Pub. No.: US 2009/0139668 A1
(43) Pub. Date: Jun. 4, 2009

(54) FIRE CURTAIN SYSTEM

(75) Inventor: Denis Naylor, Sheffield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: BRADLEY LOMAS ELECTROLOK LTD., Sheffield (GB)

(21) Appl. No.: 11/949,293

(22) Filed: Dec. 3, 2007

(51) Int. Cl. E06B 9/68

(52) U.S. Cl. 160/310

(57) ABSTRACT

A fire curtain system comprises a fire-resistant fabric curtain (1) adapted, in use, to be stored as a roll and installed at an elevated location; means to retain the curtain (1) in its rolled, non-active condition in a non-fire or non-test situation; means to activate, or deactivate, the retention means in a fire or test situation, whereby the curtain is deployed by unrolling in a failsafe, gravity fall mode at a relatively low descent speed of about 100 to 150 mm/sec; an electric motor (9) to rewind the curtain following a test deployment or an emergency deployment; and a control system for controlling the various functions of the curtain (1) including at least one override push button or switch (19) provided at a location(s) on the “fire” side of the curtain and manually operable by any person trapped on the “fire” side to retract/rewind and raise the curtain (1) temporarily for escape purposes at a relatively high lift speed of about 400 to 500 mm/sec.

### FIELD OF THE INVENTION

This invention relates to a fire curtain system of the kind adapted to be stored horizontally in a rolled condition at an elevated location, and in a fire situation to be deployed by unrolling either automatically by a signal from a fire alarm system, or by manual intervention.

### BACKGROUND OF THE INVENTION

Such fire curtains are required to be of a fabric capable of enduring prescribed temperatures for a prescribed period of time (typically 1000° C. for four hours) and are retained in their stored condition usually by a mains supply powered electromagnetic means which when subjected to power interruption either by a signal from a fire alarm system or by mains failure as a result of the emergency situation or by backup failure, permits failsafe, gravity deployment of the curtains (in contrast to a powered drop system) usually aided by a bottom bar or other weight device attached to a lower edge of the curtain. Deployment is restricted to a relatively slow speed e.g. 100 mm/sec to avoid injury to any persons beneath the curtain. However, it is not uncommon during or after deployment of fire curtains for a person to find himself on the fire side of a curtain rather than the safe side, which leads to difficulties in effecting escape beyond the barrier provided by the curtain. To deal with this problem the provision of doors or flaps defeats the fundamental objective of a fire curtain, and consequently it has been known to provide a retraction/rewind system to raise a fire curtain temporarily to an escape height to provide an escape passage for trapped persons beneath the lower edge of the curtain, but retraction has been at the same relatively low speed of deployment.

### OBJECT OF THE INVENTION

A basic object of the present invention is to provide an improved fire curtain system.

### SUMMARY OF THE INVENTION

According to the present invention there is provided a fire curtain system comprising:—
(i) a fire-resistant fabric curtain adapted, in use, to be stored as a roll and installed at an elevated location;
(ii) means to retain the curtain in its rolled, non-active condition in a non-fire or non-test situation;
(iii) means to activate, or deactivate, the retention means in a fire or test situation, whereby the curtain is deployed by unrolling in a failsafe, gravity fall mode at a relatively low speed of about 100 to 150 mm/sec;
(iv) an electric motor to rewind the curtain following a test deployment or an emergency deployment; and
(v) a control system for controlling the various functions of the curtain including at least one override push button or switch provided at a location(s) on the fire side of the curtain and manually operable by any person trapped on the fire side to retract/rewind and raise the curtain temporarily for escape purposes at a relatively high speed of about 400 to 500 mm/sec.

### ADVANTAGES OF THE INVENTION

The invention thus provides a fire curtain system which, after deployment to the floor, or during deployment to the floor, may be rapidly raised to an escape height by manual intervention of any person trapped on the fire side of the curtain by that person operating the override button or switch, rather than the trapped person having to await retraction/rewind being initiated from a remote source, or attempting to escape underneath the curtain or around a lateral edge of the curtain.

### PREFERRED OR OPTIONAL FEATURES OF THE INVENTION

The push button(s) or switch(es), is/are provided at a prominent location(s) on a structure of a building in which the fire curtain system is installed.

Operation of the button(s) or switch(es) connects the electrical supply to the rewind motor which rewinds the curtain at the relatively high speed of circa 400 to 500 mm/sec.

The push button(s) or switch(es) is/are of a type where on release the circuit is automatically opened switching off the supply to the rewind motor and causing the curtain to commence deployment at the controlled descent speed in the region of 100 to 150 mm/sec.

The control system includes a group control panel which interfaces with the alarm system and provides AC/DC voltage, and by a motor control circuit which rectified the AC voltage, regulates the power supplied to the motor and controls the speed of descent.

Protected electrical leads extend from the switches or buttons to the control system.

The curtain is housed in a headbox.

The headbox is of steel e.g. 1.2 mm galvanised steel, rated at the same temperature as the fabric of the curtain.

The headbox houses the electric motor to effect partial or full retraction or rewinding of the curtain.

The curtain is wound onto a roller of circular section.

The roller comprises a steel tube.

Within the tube, the electric motor and a speed reduction gearbox are incorporated.

A motor control circuit, housed in a steel enclosure, is mounted at an end of the headbox adjacent the motor.

The curtain is of woven glass fibre cloth with a wire reinforcement.

The curtain is retained in its non-deployed position by its associated motor operating at low voltage.

### BRIEF DESCRIPTION OF THE DRAWINGS

One example of fire curtain system in accordance with the invention is shown diagrammatically in the accompanying drawings, in which:—

FIG. 1 is an exploded perspective view of a fire curtain system in accordance with the invention;

FIG. 2 is a view in the direction of arrow A of FIG. 1; and

FIG. 3 indicates the basics of the control system.

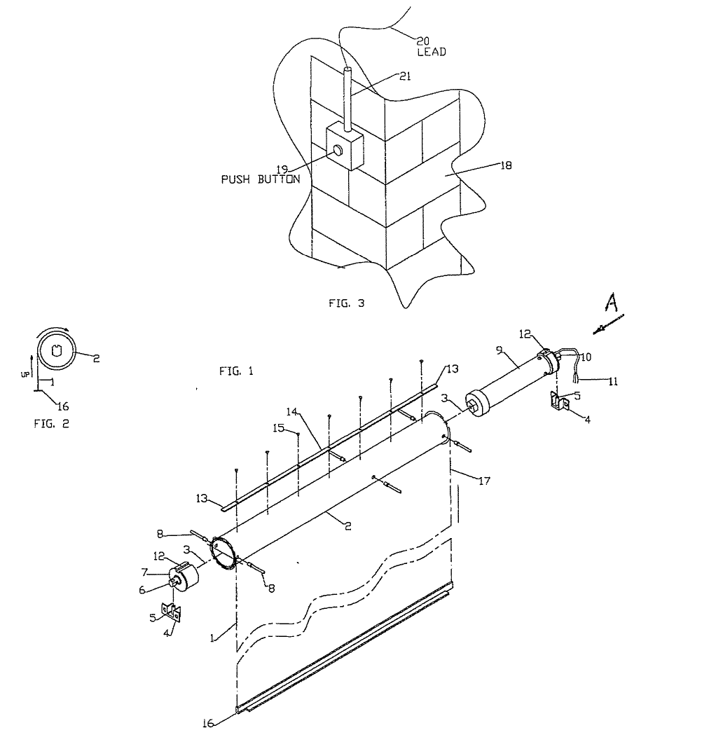

### DETAILED DESCRIPTION OF THE DRAWINGS

A fire curtain system comprises a fire-resistant fabric curtain 1 adapted to be rolled and stored on a steel tube 2 rotatable about an axis 3, the steel tube 2 being installed at an elevated location such that, in a test or a fire situation, the tube 2 is rotatable to unwind the curtain 1, and after test completion, or emergency termination, to be re-wound by reverse rotation of the tube 2.

The tube 2 is mounted to support structure by means of two spaced-apart brackets 4 each having a pocket 5, one pocket being for reception of a stub shaft 6 of a bearing assembly 7 adapted to be fitted into one end of the tube 2, and secured by rivets 8. Into the other end of the tube 2 is inserted an electric motor assembly 9 having a stub shaft 10 for insertion in, and reaction against, the sides of the pocket 5 of the other bracket 4. Electrical leads 11 extend from the motor assembly 9.

Both the bearing assembly 7 and the motor assembly 9 have a longitudinal groove 12 to receive a welded seam (not shown) inside the tube 2. A bar 14 is inserted into a pocket of the curtain 1 and secured by means of a series of screws 15, whilst the other end of the curtain 1 is attached to a bottom bar 16, the weight of which assists in deployment of the curtain 1 under gravity, either in a test mode or an alarm mode.

Adjacent an edge 17 of the curtain 1, or the endmost curtain if several are arrayed end to end for a particular area requiring fire curtains, is a support structure 18, brickwork being indicated, but a steel column, or concrete wall etc would also be suitable, on which structure 18 is mounted a manually operable push button 19 with electrical leads 20 housed in a conduit 21.

The rolled up curtain 1 and steel tube 2 are conventionally housed in a rectangular head box (not shown) and a control system for controlling the various functions of the curtain are conventionally housed in a steel enclosure (not shown) also mounted in an elevated location adjacent the motor end of the head box, to which enclosure the leads 20 from the push button 19 extend.

Conventionally, the tube 2 is prevented from rotation under the weight of the bottom bar 16 and hence is prevented from unwinding the curtain to its deployed test or emergency position by an electromagnetic clutch (not shown). However, the clutch is released e.g. by cutting, or loss of electrical power in either a test mode or an emergency mode, whereby the tube 2 is released and the curtain 1 is permitted to fall, under gravity at say 100 to 150 mm/sec.

Should a person find himself on the “fire” side of the curtain 1, then pushing the button 18 activates the control system to override deployment and to activate the motor assembly 9 to retract, or rewind, the curtain 2 at a relatively high speed e.g. 400-500 mm/sec temporarily, to provide an escape route beneath the bottom bar.

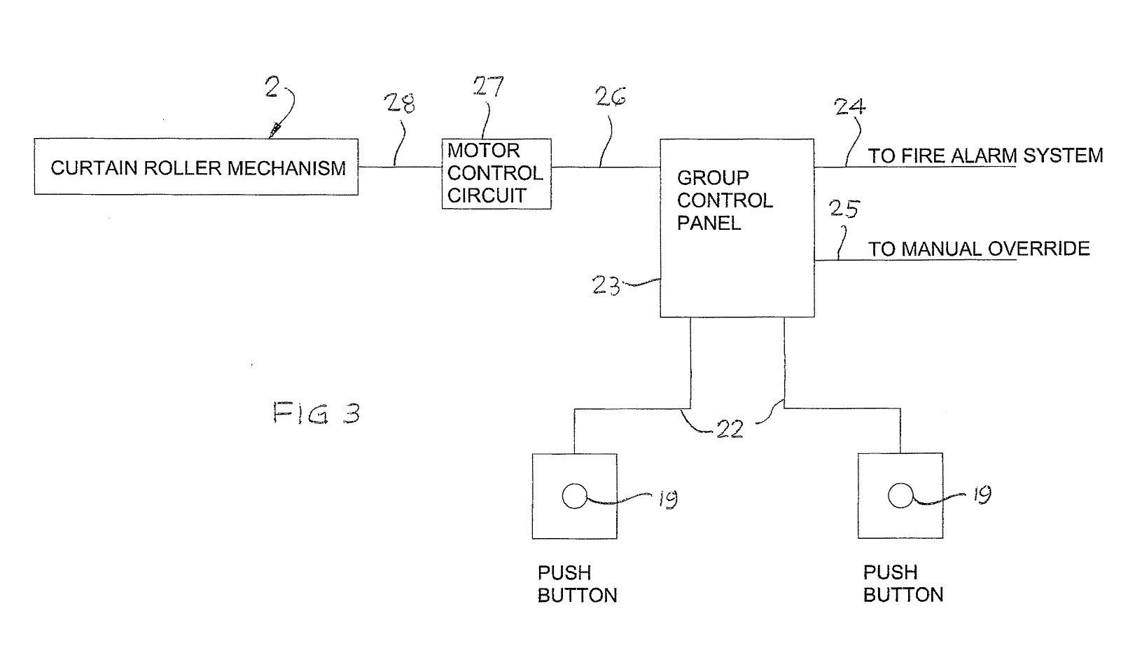

As shown in FIG. 3, the two manually operable push buttons 19 on either side of the curtain 1 are connected by leads 22 (housed in conduits 21) to a group control panel 23, with a lead 24 to the associated fire alarm system, a lead 25 to a manual override. From the panel 23 also extends a lead 26 to a motor control circuit 27, and from the circuit 27 a lead 28 to the motor assembly 9 of the curtain roller mechanism including the steel tube 2.

What we claims is:

1. A fire curtain system comprising:—
(i) a fire-resistant fabric curtain adapted, in use, to be stored as a roll and installed at an elevated location;
(ii) means to retain said curtain in its rolled, non-active condition in a non-fire or non-test situation;
(iii) means to activate, or deactivate, said retention means in a fire or test situation, whereby said curtain is deployed by unrolling in a failsafe, gravity fall mode at a relatively low descent speed of about 100 to 150 mm/sec;
(iv) an electric motor to rewind said curtain following a test deployment or an emergency deployment; and
(v) a control system for controlling the various functions of said curtain including at least one override push button or switch provided at a location(s) on the “fire” side of said curtain and manually operable by any person trapped on said “fire” side to retract/rewind and lift said curtain temporarily for escape purposes at a relatively high lift speed of about 400 to 500 mm/sec.

2. A fire curtain system as claimed in claim 1, wherein said at least one push button or switch, is provided at a prominent location(s) on a structure of a building in which said fire curtain system is installed.

3. A fire curtain system as claimed in claim 1, wherein operation of said button(s) or switch(es) connects an electrical supply to said rewind motor which rewinds said curtain at said relatively high lift speed of circa 400 to 500 mm/sec.

4. A fire curtain system as claimed in claim 2, wherein said at least one push button or switch is of a type where, on release, electrical supply to said rewind motor is automatically switched off causing said curtain to re-commence deployment at said relatively low descent speed.

5. A fire curtain system as claimed in claim 1, wherein said control system includes a group control panel which interfaces with an alarm system and provides AC/DC voltage, and by a motor control circuit which rectified the AC voltage, regulates the power supplied to said electric motor and controls said relatively low descent speed.

6. A fire curtain system as claimed in claim 1, wherein protected electrical leads extend from said at least one push button or switch to said control system.

7. A fire curtain system as claimed in claim 1, wherein said curtain is housed in a headbox.

8. A fire curtain system as claimed in claim 7, wherein said headbox is of steel e.g. 1.2 mm galvanised steel, rated at the same temperature as the fabric of said curtain.

9. A fire curtain system as claimed in claim 7, wherein said headbox also houses said electric motor to effect partial or full retraction or rewinding of said curtain.

10. A fire curtain system as claimed in claim 1, wherein said curtain is wound onto a roller of circular section.

11. A fire curtain system as claimed in claim 10, wherein said roller comprises a steel tube.

12. A fire curtain system as claimed in claim 11, wherein within said tube, said electric motor and a speed reduction gearbox are incorporated.

13. A fire curtain system as claimed in claim 7, wherein a motor control circuit, housed in a steel enclosure, is mounted at an end of said headbox adjacent said electric motor.

14. A fire curtain system as claimed in claim 1, wherein said curtain is of woven glass fibre cloth with a wire reinforcement.

15. A fire curtain system as claimed claim 1, wherein said curtain is retained in its non-deployed position by said electric motor operating at low voltage.
